(19) United States
(12) Patent Application Publication
(10) Pub. No.: US 2022/0122167 A1
(43) Pub. Date: Apr. 21, 2022

(54) SYSTEM, SERVER AND METHOD FOR PROTECTING THE HEALTH AND WEALTH OF NATIONS

(71) Applicant: Frances Newton Stacy, Sparks, NV (US)

(72) Inventor: Frances Newton Stacy, Sparks, NV (US)

(21) Appl. No.: 17/505,421

(22) Filed: Oct. 19, 2021

Related U.S. Application Data
(60) Provisional application No. 63/093,583, filed on Oct. 19, 2020.

(51) Int. Cl. G06Q 40/02; G06Q 40/00

(52) U.S. Cl. CPC G06Q 40/02; G06Q 40/12

(57) ABSTRACT

The systems and methods described herein are directed toward the recovery of an unsustainable debt growth. In some embodiments, the system includes a computer implemented method of creating an amount of interest free currency in an amount approximately twice that of 50% to 75% of a current debt. In some embodiments, the system includes paying off the 50% to 75% of the current debt with the interest free currency. In some embodiments, the system includes replacing the paid off portion of the current debt with the remaining interest free currency. In some embodiments, the system is configured to determine a sustainable angle for debt growth. In some embodiments, the system is configured to determine a sustainable angle for debt recovery.

### CROSS-REFERENCE TO RELATED APPLICATION

This application claims the benefit of priority from U.S. Provisional Application No. 63/093,583, filed Oct. 19, 2020, entitled “SYSTEM, SERVER AND METHOD FOR PROTECTING THE HEALTH AND WEALTH OF NATIONS”, which is incorporated herein by reference in its entirety.

### BACKGROUND

Central bankers attempt to smooth the long-run upward path of economic growth, but if economic and financial history has taught us one thing, it is that significant downturns will always occur. Downturns are simply the cost of previous growth. Occasionally, such recessions or disruptions are serious enough to earn the appellation crisis witnessed in 2008. Rarely, they even earn the term depression (i.e., after 1929). Downturns are unavoidable and usually occur as the result of either surplus or deficit of lending and money creation in the economy. There is a long-standing debate in the field of economics about whether money creation causes or amplifies business cycles.

The economic policy response to a national emergency which slows commercial economic activity (e.g., COVID-19) is in essence a period of above average lending and money creation. All of newly created money is borrowed into circulation via a ledger entry in both the asset and liability column on the bank balance sheet. If the debt is outstanding it contributes to the aggregate money supply. Once the debt is repaid it is extinguished from the asset and liability columns and no longer counted in the money supply. The interest collected remains in the interest or profit column on the bank balance sheet. Thereby this method of borrowing money into circulation and then extinguishing upon repayment keeps an elasticity in the money supply. This design also ensures that the bank profit is not extinguished when the loan upon repayment comes off the books.

There are 5 major faucets (i.e., variables) that can be adjusted to expand the money supply: interest rates, reserve requirements, quantitative easing, government spending, and taxes. More than ten years ago, the Federal Reserve (also referred to as the “Fed” herein) had to combat the risk of a Great Depression-era deflation. This it did by adding to its balance sheet ledger entries backstopping the money supply with loans in addition to a lot of additional government spending. This strategy of expanding the money supply was effective at mitigating the damage of the Global Financial Crisis (GFC; 2007-2008). The economy did not collapse, nor did it return to the bliss of the Great Moderation (Bernanke, 2004). In fact, the Fed's balance sheet went from approximately $872 billion in August 2008 to $2.8 trillion in August 2012 (Federal Reserve, 2020). Adding to the money supply prevented a deflationary collapse, but in the longer term it added to the general conditions of a future national insolvency by implying a debasement of the US currency. While some may claim the contrary, this resulted in a wealth gap in the country. If the money supply expands, and output does not, inflation is the outcome, even if only later and even if only latent. Currently, the Federal Reserve's balance sheet stands at around $8.5 trillion.

The strategy of expanding the money supply using loans and additional government spending worked because from the mechanical perspective, it put enough money in circulation to facilitate the debt service and liquidity. The GFC was caused because there wasn't enough money in circulation to keep up with all the debt service and liquidity. This is because tightening occurred before the GFC that mechanically caused this. Therefore, this had to be reversed. New loans had to be issued at a record pace to fill the void in the money supply of the defaulting loans coming off of the books. It also had to be issued to allow debt service and mitigate default wherever possible.

As a result, the US money stock is being expanded significantly and rapidly but unevenly at a time where the dampening factor on growth is not from lacking funds, but from the physical constraints of a virus. What policymakers want is the upside of liquidity, without the downside of debt service. However, the short-run effects of these economic policies have barely turned the dial on growth, while their eventual effects may well undermine the long-run viability of the US economy and financial system. In short, we may end up with significant deflation today and even more inflation tomorrow.

In these troubled times, international policymakers are focused on the threat of COVID-19. The pandemic threatens not just the public's health, but also their wealth. Countries have spent incredible sums of money fighting the virus. The growth of the money supply (debt) is being expanded while the virus is constraining GDP, which is exacerbating the Debt to GDP ratio into dangerous territory in terms of both Total Debt to GDP and Public Debt to GDP. This is especially true of the United States (US). But there is a downside to this profligacy.

The downside risk is in the fact that the money supply creation on this scale cannot be discontinued because the new money is being rapidly absorbed by the service of the immense debt in all sectors. This means that the money is not in circulation for very long as the debt service reduces both the asset and liability columns as it's being repaid. This is the reason that this new money has not created meaningful inflation as it has not changed the ratio of money supply to goods and services in the economy because of its immediate use and extinguishing via debt service.

However, new money is not trickling down at the rate that it is being created. One analogy is a swimming pool. The new money feeds in from a plurality of faucets (that may become firehoses in some embodiments) which are constantly filling the pool (i.e., liquidity input). The debt service is acting as a drain that is constantly draining the pool (i.e., liquidity drain). In order to maintain the level of the pool, the combination of at least the 5 major faucets described above have to have a greater flow rate than the drain. Currently, the Fed has slowed its asset purchases. Commercial banks are tightening their lending criteria and consumer/household debt (credit cards) is softening. Those are all faucets and each of those flows is being reduced, and if the flow rate continues to be reduced as the drain rate remains constant (or increases) we will once again see the pool level (liquidity) go down and once again see liquidity risk in addition to solvency risk come back into the crisis (i.e., COVID) recovery equation.

The United States is facing either a comprehensive and severe restructuring or eventual default on its debt. The US has taken on a record amount of debt to come out of the Covid crisis, which has exacerbated and uncovered some of the longer-term consequences of the limits in our monetary system. Our system now has a new precedent for liquidity demand in order to service the record amount of debt in the system. But because of potential debt service concerns, interest rates have to remain very low in order to not have the compounding interest and principal grow faster than the ability to create new money to service the debt. This keeps us from being able to meaningfully raise rates in an attempt to quell inflation. As the level of debt service grows, we are even at risk for negative rates at some point as this would be preferable to default.

The widening of the wealth gap will be further exacerbated by the necessary increase in taxation to continue to service the record amount of debt. However, this tax onus is predictably paid by fewer and fewer people as this wealth gap widens. As this natural consequence to our monetary system accelerates the percentage of people who are getting poorer, it is compounded by their having to pay more for credit as their interest rates are typically higher. It affects the system because the lower income bracket sometimes gets burdened to a point where they cannot produce as much and participate in our GDP. For instance, as the amount of people on welfare grows, the money supply grows as the government borrows to pay for their welfare, but they are not contributing to GDP because many cease to produce anything. As a consequence of the growth in debt and less production, those who are contributing to GDP are now being taxed more and more, which mitigates growth. As GDP eventually suffers as the debt continues to grow and this exacerbates the debt to GDP ratio into unsustainable territory until the country needs a severe restructuring.

Given the fact that the US Dollar is the world's reserve currency, a significant restructuring could threaten that status, which would cripple the US' ability to come out of that restructuring via bailouts as we have previously. This restructuring is a mathematical certainty because of the structural element of the money supply, which is that of a reverse pyramid. This is because when you borrow/create $100, which is the base, you owe $100 plus interest, and given that interest is not yet negative, that number is greater than $100. Therefore, there is never enough money in the system to cover all of the debt. (100+i>100). The top of the pyramid will grow at an increasingly faster rate as the interest compounds. Every reverse pyramid structure will inevitably reach a point where the base cannot substantiate the weight at the top, so it collapses. This has already happened and is what caused the Great Depression and the Global Financial Crisis. Because of our current structure, this is mathematically destined to happen again.

At the end of July 2020, Fitch Ratings questioned the country's long-term financial viability by moving the AAA-rated country's credit outlook from ‘stable’ to ‘negative’ (Fitch Ratings, 2020). Therefore, there is a need to avoid the deflationary risks of today without adding to the inflationary risks of tomorrow.

### DRAWINGS DESCRIPTION

FIG. 1 is an exemplary illustration of the model used by the system to generate a dynamic chart according to some embodiments.

FIG. 2 shows values that are plugged into the model to generate the dynamic chart of FIG. 3 according to some embodiments.

FIG. 3 shows a dynamic chart generated by the system according to some embodiments.

FIG. 4 shows a graph of Total Assets (Less Eliminations from Consolidation) obtained from the Board of Governors of the Federal Reserve System (US).

FIG. 5 illustrates a debt recovery chart according to some embodiments.

FIG. 6 shows a debt recovery timeline calculation according to some embodiments.

FIG. 7 illustrates a computer system enabling or comprising the systems and methods in accordance with some embodiments of the system.

### DETAILED DESCRIPTION

An eventual restructuring or default is always painful for tax payers as copious new debt has to be issued to backstop the system. This occurred with bailing out the banks during the Global Financial Crisis. Growing America's debt grows America's tax burden, which is felt by Americans and will continue to weigh on future generations. Because of the reverse pyramid structure the question is not if, but when this restructuring will occur. While the Fed can delay this restructuring, it cannot stop it because the delay is because of further issuance of debt, which puts additional pressure on that structure. As the United States (US) loses its dominance over global Gross Domestic Product (GDP) alongside having an increasingly widening wealth gap, it's credit rating will eventually be questioned, which will likely be a catalyst to put the USD (US Dollar) as the world's reserve currency at risk. Without reserve currency status, it's hard to imagine how not having that demand for our debt will allow us to grow out of a restructuring at the same rate as America has grown previously. In addition to the structural issue, the wealth gap widening will further foment social angst and political extremes. This will affect all citizens and it will be more challenging to remain a global leader in innovation.

Structurally, when one grows the money supply to keep up with debt service, one has to compensate for the fact that debt service of principal actually removes money from circulation and therefore we need to have enough liquidity in the system so that principal that's serviced can be removed and there is still enough liquidity to be made available for the production of goods and services. This means that the rate of new debt must continue to climb higher. This becomes a vicious cycle until it becomes so untenable to keep up with the debt service that we need a restructuring, which is severe like the Great Depression and the Global Financial Crisis.

The ever-widening wealth gap accelerates the timeline around restructuring. This is because the expansion of credit treats creditors and debtors differently. The creditors get wealthier through the addition and compounding of interest on the debt. Conversely the debtors can subtract the compounding of that interest from their wealth, which de facto slows their curve of wealth creation. Also, the poorer a debtor is the more interest he has to pay to compensate for the risk of lending to him. This means he de facto pays more for everything, which further weighs on his wealth accumulation and future. This wealth gap effect has been reiterated over every business cycle until we have the picture that we see today where currently the top 40% and the lower 60% statistically live in different countries as the lower 60% actually have the quality of life we think of in a 3^{rd} world country.

There have been many critics over the centuries of the notion of a government borrowing from itself at its own cost. On the surface this appears absurd. However, there is an entire structure that goes with debt that few understand and yet is a pertinent tool to adjusting the money supply and protecting an economy from unsustainable inflation or deflation, which is obviously important. Debt provides an elasticity to the money supply. When debt is added the supply increases, yet when the debt is paid or written-off the supply decreases by that amount. This puts an automatic deflationary premise into the system, which helps control inflation. Money leaving the system also creates demand for new money coming into the system which is crucial to maintaining the reverse pyramid structure as more money has to come into the system to service the principal plus interest that came with previous injections. The central bank controls lending as way of either increasing this issuance or reducing it to accomplish their dual mandate of price stability and maximum sustainable employment.

There are some potential theories and solutions being discussed and proffered. First, there is Modern Monetary Theory which suggests that the government can essentially spend as much as it wants because they can print as much as they want (Investopedia). They further claim that inflation is contained by taxation because taxation is deflationary. This is true because taxes pay off debt, however, this solution presumes that the government will always be able to service its debt and that taxes can go up commensurately to service that debt, which grows with money printing as all of that money printing is actually further borrowing. This borrowing accelerates the reverse pyramid to an unsustainable point. The percentage of income tax participation goes along with the wealth gap and as the business cycles carry forward, we can see that the wealth gap will continue to widen and the onus will be increasingly on the top earners to pay for the debt service.

Cryptocurrency is growing increasingly popular around the discussion that it could disrupt the current monetary infrastructure, which some argue should be debt free and decentralized. A study of the history of currency shows how this decentralized structure was tried before even though the technology wasn't available. First, there were many currencies in circulation prior to a national banks when settlers traded goods. The problem as the states got more connected and commerce grew is that there was no way to really see how much money was in circulation and how it was distributed over all of the people. The challenge with this is not understanding if all citizens have access to money and thereby access to goods. This multitude of currencies was solved by coinage acts defining currency. However, due to an ultimate shortage in metals and coins, it was determined that paper money was more efficient and easier to carry. How much paper currency should be issued has been an age old question followed with what do you do if you issue too much or too little? Ultimately the central banking structure came over from Europe to solve these issuance and money supply problems. Further, inflationary and deflationary risk in our modern society can only be measured and monitored through understanding how much money is in the system juxtaposed to the goods. This can only be accomplished well if there is one yardstick (one currency) and if it's managed through one place doing the issuing. So, decentralizing this operation almost assures chaos as these risks can no longer be monitored and managed. How will investors and free markets run without the knowledge of how much risk they are taking? Disruption deals with fully understanding the function of something and through that understanding innovating in order to make the operation better and more efficient. Decentralizing the currency does not make anything more efficient.

Bitcoin and most other cryptocurrencies cannot disrupt our current fiat system is because they cannot manage supply. Supply includes the supply/demand ratio consideration when it comes to price and furthermore supply and issuance determines the ratio of money to goods and services. Given that goods and services is not a constant, and is difficult to control, one cannot adequately manage this ratio with a fixed supply, as is the case with Bitcoin. Other Cryptocurrencies have either unlimited supplies or investment committees that determine increases in supply, which is up to their factors. What if way too much or too little is created? Without the elasticity intrinsic in the debt mechanism, how does one remove crypto from circulation? The consequences of having too much or too little currency are dire as history shows during periods of extreme inflation or extreme deflation. These questions around supply and issuance do not make cryptocurrency a good replacement for fiat. This doesn't consider all of the debate around how much energy is required to mine crypto. This is why central banks are going to come up with their own digital currencies to innovate with the technology, but without losing the function of money supply control. To the extent that cryptocurrency presents the potential of multiple yardsticks when considering the money supply, it would undermine the Fed's ability to accomplish its dual mandate. Given that, it's predictable that the Fed would outlaw crypto if it threatens the function and legal authority given to the Fed by Congress.

How can we change the fate of an eventual and painful restructuring? There is no question that the restructuring is caused by monetizing the currency through debt. However, those that claim that all US currency should be spent into circulation rather than borrowed into circulation haven't given a good structural adjustment solution to the problem of what if too much currency is issued either initially or as a result of a severe adjustment to the level of GDP as just occurred with Covid? Too much currency will cause inflation. Of course, critics of the system would claim that is exactly what's happening now as we come out of Covid. However, it's happening now with the deflationary pressures of debt service and the Fed having the tools to ameliorate inflation. We can only imagine how much worse it would be if we just added currency to our system and had no way to adjust it as further data comes in about GDP and inflation. Also, it would be worse if money were not constantly exiting the system via public and private debt service. The debt structure puts an important elasticity in the system that without which we would be at risk for everything being more expensive tomorrow than it was yesterday, and therefore we should have already bought everything. This would obviously be discriminatory to our future generations.

However, we can clearly see that the debt system elasticity gives birth to the business cycle. And because creditors and debtors are treated differently throughout the cycle, we can see that continuous iterations of the business cycle creates an ever widening wealth gap. There are a multitude of consequences to a widening wealth gap such as a rise in crime arguably being largely a byproduct of poverty. Instances of crime breed so much damage to the sanity and well-being of citizens. So how do we take the benefits of the elasticity in the money supply with debt and ward off some of the unintended social consequences?

In some embodiments, a solution provided by the systems and methods described herein (collectively referred to as the “system”) includes taking a hybrid approach of the debt free and debt structure to benefit from the stability of the debt-free structure without giving up the benefits of the elasticity in the money supply of the debt structure. In some embodiments, the system includes replacing the reverse pyramid with a rectangular base that has a reverse pyramid component stabilized by the base. In some embodiments, this structural adjustment would be akin to minimally invasive surgery. In some embodiments, this is because this keeps the central bank in place to manage the money supply and attendant inflationary/deflationary pressures. In some embodiments, it keeps the interest component in place in order to continuously incentivize demand for our debt. In some embodiments, while Congress has the Constitutional authority to issue currency, realistically they do not have the skill set or the resources that that Fed has to continue this role.

In addition to stability being added to the current structure, the system includes a method to reduce the overall debt burden in the current system in order to keep taxes low enough to produce our way out of Covid. While politicians want to “tax the rich,” in some embodiments that will not sustainably pay for all of the new debt from Covid. In some embodiments, the share of federal taxes paid by households in the highest quintile increased from 55 percent in 1979 to 69 percent in 2017. (CBO) In some embodiments, these figures will likely have increased during Covid. In some embodiments, while we surmise that the highest quintile can afford it, taxing them more and more could weigh on growth as it may disincentivize some from reaching to increase their production and income. Also, as increased taxes are paid, we will have an increase in money that's extinguished out of the system during the recovery according to some embodiments. In some embodiments, there are additional risks in the timing of all of this, which are potentially worsened by gridlock with Congress on fiscal packages and debt ceiling issues.

In some embodiments, by doing a hybrid restructuring we are not leaving as much of the above to chance. In some embodiments, the system is configured for restructuring any financial system and any balance sheet, however for simplicity in teaching those of ordinary skill to make and use the system the Fed balance sheet is used as a non-limiting example model. In some embodiments, the system includes taking approximately 62% the current balance of the Fed Balance sheet and create 2× that amount of debt free money, like printing a dollar bill instead of a T-bill. In some embodiments, the system includes paying off the 62% figure of principal and interest. In some embodiments, the system is configured such that the principal when the debt is repaid will immediately be extinguished from the money supply which is precisely why we had to create double that. Otherwise, we would have a deflationary collapse as that debt was paid off. In some embodiments, the system is configured such that the interest on that debt will be paid according to Section 7 Division of Earnings of the Federal Reserve Act to honor the current law in the interest of minimal systemic disruption. In some embodiments, the remaining amount after paying 62% of the debt is debt free, which would mean that it would not have an interest obligation and would not ever mature or otherwise come off of the ledger. In some embodiments, debt free money includes money that is not monetized as debt and/or not borrowed into circulation. In some embodiments, the system creates a monetary base that would ensure that the liquidity in the system would never dip below this amount. In some embodiments, the system is configured such that the remaining 38% is the debt based and elastic component of the debt in the system, which remains on the ledger as such according to some embodiments. The implementation of some embodiments of the system results in the same amount of money in the system, but a reduction of debt by around (±10%) 60%. In some embodiments, this returns the financial system to a sustainable angle of debt growth, ameliorates the wealth gap, and would drastically reduce the tax burden.

Importantly, in order to maintain an elasticity in the money supply and an economic cycle that fluctuates albeit less drastically, the system is configured to grow the money supply and attendant debt at a sustainable angle so that reversions to the mean are not as violent, which means that the wealth gap effect from the business cycle is reduced in severity. In some embodiments, the sustainable angle is 11.25-22.5 degrees. In some embodiments, this restructuring reduces the overall national debt burden, which increases the probability that we can take care of all of the unfunded liabilities that weigh on our future as Americans. In some embodiments, the system is easily be employed with a central bank digital currency as the non-debt and debt ledger could be combined to manage the money supply. Also, Congress has the authority to issue currency without a debt obligation according to some embodiments. In some embodiments, the system is apolitical, and it does not favor a class or race or age. In some embodiments, reducing the overall national debt before another credit crisis is literally beneficial to all including the Fed.

In some embodiments, the system includes a hybrid model between debt free and debt money as a medium of exchange, which gives the advantages of both and each lessens the disadvantages of the other. In some embodiments, the system includes a formula to calculate the base to get the debt on the sustainable trajectory of expanding within one or more of an angle range of 22.5 degrees and/or an average of 22.5 degrees as an upper limit and/or an angle range of 11.25 degrees and/or an average of 11.25 degrees as a lower limit.

In some embodiments, the system includes forgiving now any interest accruing to the US central bank that will, later, end up in the US Treasury under Section 7 of The Federal Reserve Act of 1913. In some embodiments, the forgiveness is implemented by computer instructions as part of a computer implemented method. In some embodiments, the system includes a coordination of fiscal and monetary policy that is configured to create growth and stability in financial markets. In some embodiments, the system is configured to take the existing outstanding interest obligation that would be allocated when paid to the interest/profit column on the bank balance sheet and forgiving it as to reduce debt service as to reduce the drain rate because of requiring less debt to be serviced and less new debt to be created to service. In some embodiments, this forgiveness would initially occur with the Fed Balance Sheet by adjusting the chronological disbursement described in Section 7 of the Federal Reserve Act.

In some embodiments, the system includes a stimulus effect by releasing funds. In some embodiments, releasing funds acts as an indirect source of countercyclical liquidity. In some embodiments, releasing funds includes the same effects of a fiscal outlay. In some embodiments, outlays are payments made (generally through the issuance of checks or disbursement of cash) to liquidate obligations. In some embodiments, outlays during a fiscal year may be for payment of obligations incurred in prior years or in the same year. In some embodiments, the stimulus effect is created by reallocating future debt service and thereby reducing the amount of new money needing to be borrowed for Fiscal expense and by reallocating the money supply earmarked for Fed interest/profit into general circulation via Fiscal expense.

In some embodiments, the system includes a stability effect. In some embodiments, the released funds will not add to the money supply, whilst also reducing the US Treasury's fiscal burden. In some embodiments, the system is configured to recycle the released funds into the public and private financial system instead of directing the released funds into the Fed interest/profit column. In some embodiments, if the funds would eventually end up in the US Treasury but are recycled into the public and private financial system instead, the US Treasury therefore suffers no net loss, nor does the central bank. In some embodiments, the central bank does not have to create new funds or purchase newly-issued US debt. In some embodiments, the system described herein is a straightforward, legal, mechanical adjustment to the Federal Reserve's balance sheet that provides for the advancement of central banks ‘ultimate goal of a stable and active economy by smoothing rate changes and also smoothing the upward path of growth.

In some embodiments, rate changes affect new debt. In some embodiments, the system is configured to enable money supply/debt growth/GDP without using rate changes. In some embodiments, the system includes a reallocation of existing debt. In some embodiments, the released funds will not add to the money supply in terms of new debt, but will add to general circulation some of the existing supply, which is currently earmarked for being paid into the interest/profit column on the balance sheet.

In some embodiments, the system described herein is not traditional debt forgiveness because it does not reduce the aggregate money supply as a typical reduction in outstanding debt. In some embodiments, this is because a government (e.g., the United States) cannot default on interest payments that is owed only to that government. In some embodiments, the system is configured to take advantage of this principle by reallocating Treasury income from tomorrow to indirect expenditure today.

In some embodiments, the system described herein is not a monetary expansion because it does not add to the aggregate money supply (new debt) as do quantitative easing programs. In some embodiments, the system is configured to create growth and stability by allocating existing currency according to the methods described herein.

In some embodiments, the system includes an interwoven relationship between the money supply, the level of new credit, the level of debt, interest rates and inflation. In some embodiments, the interest column of the central bank balance sheet is not included in its assets and liabilities columns, which are those used to calculate the money supply. In some embodiments, the interest column is, in fact, superfluous to those numbers by design. In some embodiments, the reason that the interest column is superfluous is so that the interest is not extinguished from general circulation along with the credit that created it whenever a debt is repaid. In some embodiments, the interest column constrains the existing supply for debt service.

In some embodiments, the money supply named ‘interest’ is instead derived from loan activity and remains in circulation after a debt is repaid in full. In some embodiments, this makes sense, especially when we remember that interest payments are bank profits. In some embodiments, the higher the interest rate in the short-term, the lower that of inflation in the long term because higher interest rates mitigate/discourage the rate of new loans issued, which reduces the faucet flow while drain flow remain constant or increasing thus reducing the overall pool level thus reducing the money supply to goods ratio that ultimately controls price levels that indicate inflation. In some embodiments, in the long-run, this relationship is reversed. In some embodiments, interest payments and their role in permanent structural inflation was a part of the original design of the money supply and the dynamic debt structure but has never been used as a system configured to create growth and stability.

One reason that others may not have conceived a similar system is that it might appear as if the government is defaulting on its debt. This is not the case because the system comprises an interest rate restructuring, not a principal write-down or write-off according to some embodiments. In some embodiments, instead of indirect interest rate manipulation, the system is configured to directly manipulate interest rates. In some embodiments, the system is enabled by the ability of the Fed to interpret its mandate and create actual policy as it sees fit when undergoing a policy review. An example of this ability that is in periods of international turmoil, including the US's credit rating downgrade of 2011, capital markets have flocked to the US dollar as the only true safe haven. In some embodiments, the system includes a central bank adjustment, and not a Treasury adjustment, and therefore enables the Treasury to expand its fiscal response without attendant debt service.

In some embodiments, the system is configured to provide a non-traditional method of fiscal expansion to lessen the economic burden from COVID and aid the rate of a recovery. In some embodiments, the system is not a so-called debt-monetization, in that no new funds are created to pay for old debts. In some embodiments, the proposal is the exact opposite of a monetization, in that it does nothing to add to the nominal dollar stock at all.

In some embodiments, the initial step is to address the Fed Balance Sheet. In some embodiments, the system is configured such that no one has to “take a haircut” to make the adjustment using the system. In some embodiments, not taking a haircut is due to eventually returning some profits to the Treasury per the Federal Reserve Act. In some embodiments, the adjustment by a computer implemented method is a change in the chronological order of operations per Section 7 of the Federal Reserve Act. In some embodiments, the adjustment would alleviate some treasury debt service (funded by Federal taxes) without costing the Fed or citizens or Treasury anything. In some embodiments, the system is preferable to negative interest rates, which will be applied if the alternative is a default.

In some embodiments, the system is configured to be applied to commercial banking, corporations or any entity that has a balance sheet that incorporates debt as the primary goal is to alleviate overall debt and thereby debt service to reduce default risk. However, in this application, the adjustment will cost one of the parties according to some embodiments. In some embodiments, like the bitter pill of negative interests, the cost may be preferable to the greater loss of default. In some embodiments, the adjustment comes out of the interest column because it doesn't affect the asset or liability columns. In some embodiments, as in the case of the Federal Reserve Balance sheet, this doesn't affect the overall money supply, which directly controls both inflationary and deflationary risks. In some embodiments, this feature of not affecting those risks is precisely what makes these embodiments of the system a simple and elegant solution.

In some embodiments, the mechanics of the balance sheet adjustment with the Fed and the commercial banks are the same. In some embodiments, the difference is the relationship between the borrower and lender as delineated in Section 7 of the Federal Reserve Act. In some embodiments, per this Act the lender would return some of its profit to the borrower. In some embodiments, although the Fed is not a public or non-profit and is a for profit with shareholders (commercial banks) it does return some profit to the treasury. In some embodiments, this is because under the Fed Reserve Act it is the only lender that the Treasury can borrow from.

In some embodiments, in a normal lender/borrower transaction the lender doesn't give profits above expenses and shareholder coupons back to the borrower. Therefore, in some embodiments, the same mechanical adjustment in the commercial banking scenario would be a “haircut” for the lender in favor of the borrower. Though this would not be ideal for the lender and their shareholders, it would become preferable to default as losing some profit would be better than losing principal and interest in the event of a default according to some embodiments. In some embodiments, the mechanical adjustment are useful if the commercial bank were to fail a stress test. Again, in some embodiments, it is preferable to preemptively adjust the profit rather than having to adjust their loan to deposit ratio or other adjustments to meet stress test requirements.

In some embodiments, the wealth gap would be most served by a Central Bank adjustment because it would create the effect over the widest sphere. However, in some embodiments, the borrower usually, but not always, has less than the lender. So, to favor a borrower on the lower end of the spectrum would do some work to either reduce or simply keep from expanding the wealth gap if applied widely enough, but it would reduce the difference according to some embodiments.

In some embodiments, all countries who continuously add to their debt and for unanticipated or unforeseen events that slow commercial activity (e.g., the COVID epidemic) cannot commensurately grow their GDP to pay down the debt either have had to restructure their debt or will when they reach the precipice of too much debt to easily service. In some embodiments, according to Ray Dalio's detailed research, this typically happens when the country reaches 365% total debt to GDP. The US government post COVID is currently at 362% and climbing.

One way to predict the potential sustainability of the debt curve is to analyze the angle by which it is growing. This conventional analysis has been historically done with asset prices. In some embodiments, the analysis system and methods presented herein include one or more of stock prices, asset prices, bonds, and commodities. There is an assumption in technical analysis that says that something that grows too quickly will at some point experience a reversion to the mean. There is a further assumption that the reversion to the mean will likely occur at double the angle from when the stock departed from a sustainable rate of growth as determined by a sustainable angle. In some embodiments, this sustainable rate of growth doesn't have an intrinsic reversion to the mean and has been determined to grow on an angle between 11.25 and 22.5 degrees.

In some embodiments, if a country reaches approximately 365% total debt to GDP and approximately 150% public debt to GDP, then the likelihood of instability is markedly increased. Further, in some embodiments if the growth trajectory has an angle that is steeper than 22.5 degrees, then it will require a reversion to the mean to keep going. Further, in some embodiments, we know that the steeper the angle, the more severe the reversion to the mean. The calculations and data presented herein show that the debt growth in the US needs to be addressed very soon.

In some embodiments, if government, bank, or corporation does not discipline itself into addressing an unsustainable trajectory of debt growth, then markets and the laws of debt service will provide the discipline. In some embodiments, this discipline scenario usually looks like a restructuring of the debt with the assistance of the IMF. In some embodiments, if this debt crisis seems unlikely to happen in the US, attention is drawn to the fact that has happened to 48 countries over the decades (Dalio, 2019).

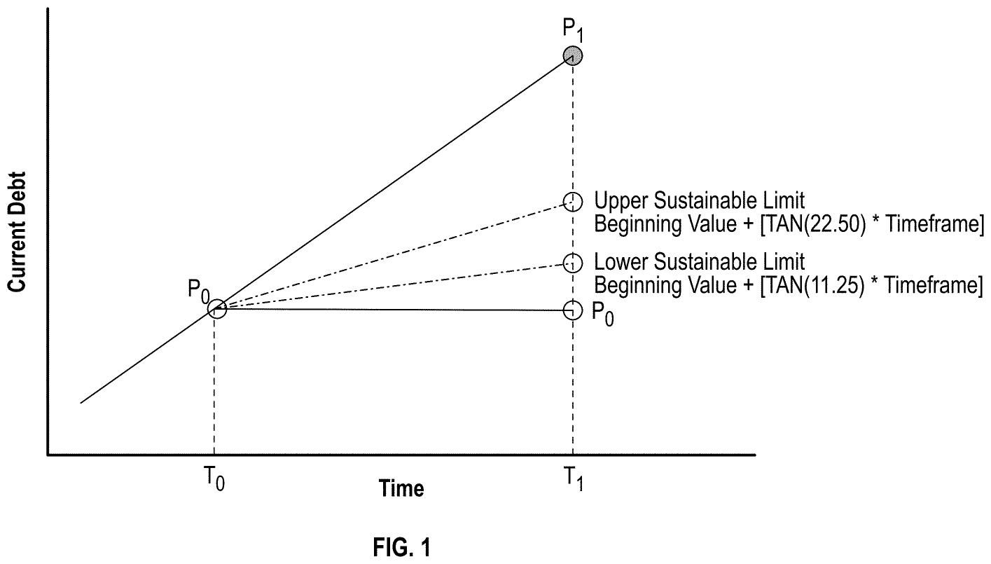

FIG. 1 is an exemplary illustration of the model used by the system to generate a dynamic chart according to some embodiments. In some embodiments, the model is stored on one or more computers comprising one or more processor and one or more non-transitory computer readable storage media. In some embodiments, the model includes:
P₀: starting price on the measured angle
P1: final price on the existing angle
T₀: starting time of the measured angle
T1: end of the time period on measured angle
Lower Sustainable Limit: the lower angle of 11.25 degrees with necessary price adjustment
Upper Sustainable Limit: the upper angle of 22.50 degrees with necessary price adjustment

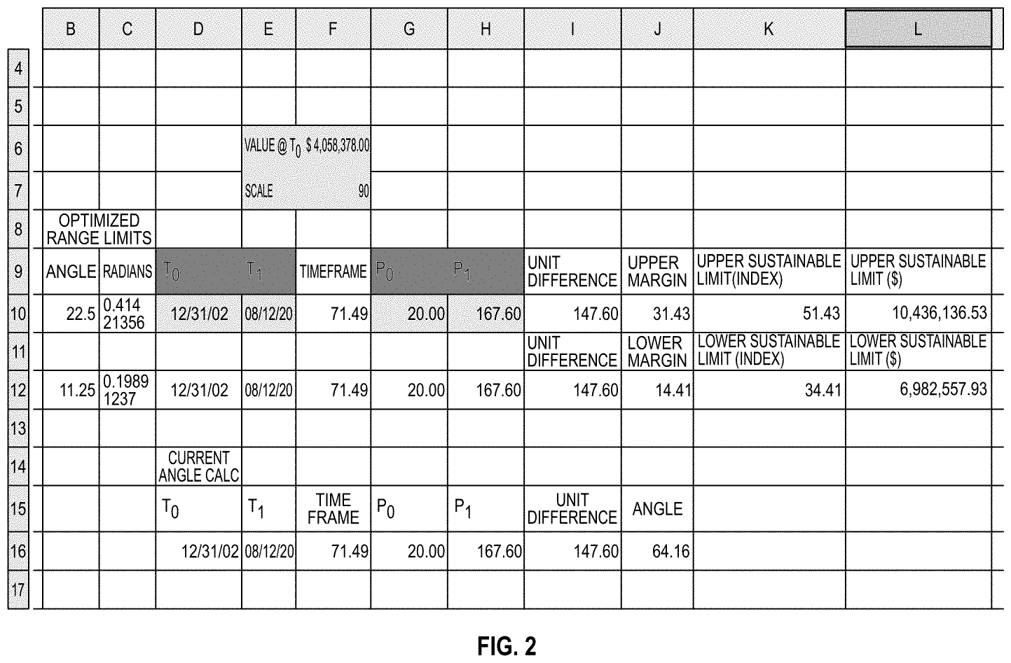

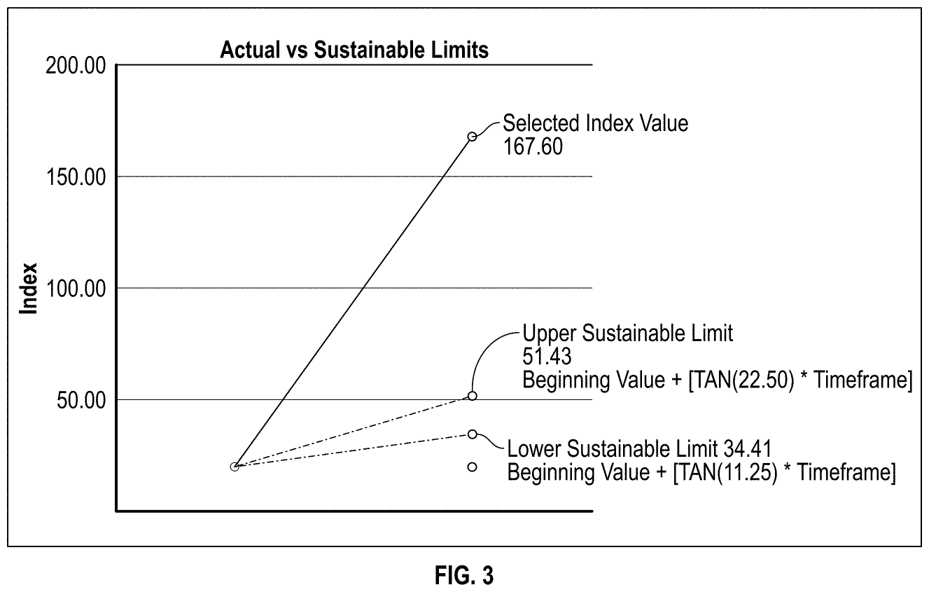

FIG. 2 shows values that are plugged into the model to generate the dynamic chart of FIG. 3 according to some embodiments. In some embodiments, the values are entered to and/or stored on one or more computers comprising one or more processor and one or more non-transitory computer readable storage media. In some embodiments, the values are entered into the system using a display that includes at least one graphical user interface (GUI) configured to accept and/or display user inputs. In some embodiments, the values include:
Line 6, Column E/F—value in Dollars are the starting time of measured angle
Line 7, Column E/F—scale in time (time period in which current angle and adjustment angles are analyzed)
Lines 8/9—labels
Line 10—22.5 degree angle calculation
Line 10, Column B—22.5 degrees angle (upper sustainable limit)
Line 10, Column C—angle measured in radians calculated with the tangent of 22.5 multiplied by the timeframe (Excel calculates radians and they are converted back to degrees)
Line 10, Column D—start date of period of analysis
Line 10, Column E—end date of period of analysis
Line 10, Column F—the number of units measured in the timeframe determined by the scale number in column 7 F
Line 10, Column G—the starting price (Po) determined by the scale on the FRED website
Line 10, Column H—the ending price (P1) determined by the scale on the FRED website
Line 10, Column I—the change in price (represented by FRED scale units) over the time period measured
Line 10, Column J—the ideal change in price if the angle were the upper sustainable limit of 22.5 degrees
Line 10, Column K—the ideal ending (P1) if the angle were the upper sustainable limit of 22.5 degrees
Line 10, Column L—the ideal ending dollar amount at the upper sustainable limit of 22.5 degrees
Line 11—labels
Line 12—11.25 degree angle calculation
Line 12, Column B—11.25 degrees angle (lower sustainable limit)
Line 12, Column C—angle measured in radians calculated with the tangent of 11.25 multiplied by the timeframe (excel calculates radians and they are converted back to degrees)
Line 12, Column D—start date of period of analysis
Line 12, Column E—end date of period of analysis
Line 12, Column F—the number of units measured in the timeframe determined by the scale number in column 7 F
Line 12, Column G—the starting price (Po) determined by the scale on the FRED website
Line 12, Column H—the ending price (P1) determined by the scale on the FRED website
Line 12, Column I—the change in price (represented by FRED scale units) over the time period measured
Line 12, Column J—the ideal change in price if the angle were the lower sustainable limit of 11.25 degrees
Line 12, Column K—the ideal ending (P1) if the angle were the lower sustainable limit of 11.25 degrees
Line 12, Column L—the ideal ending dollar amount at the lower sustainable limit of 11.25 degrees
Line 14, Column D—label for current angle of the FRED chart
Line 15—labels
Line 16, Column D—start date of period of analysis
Line 16, Column E—end date of period analysis
Line 16, Column F—the number of units measured in the timeframe determined by the scale number in column 7 F
Line 16, Column G—the starting price (Po) determined by the scale on the FRED website
Line 16, Column H—the ending price (P1) determined by the scale on the FRED website
Line 16, Column I—the change in price (represented by FRED scale units) over the time period measured
Line 16, Column J—the existing angle of the time period.

FIG. 3 shows a dynamic chart generated by the system according to some embodiments. In some embodiments, the system is configured to display the dynamic chart on a display and/or graphical user interface (GUI) using one or more computers comprising one or more processor and one or more non-transitory computer readable storage media. In some embodiments, the dynamic chart shows the current angle calculation and the calculations of the ideal angle range of 11.25-22.5 degrees to give a visual depiction of the departure and necessary reversion to the mean to reach the sustainable range. In some embodiments, the adjustment provided by the system is configured to be measured and made over any time period to determine optimization from that time period. In some embodiments, the dotted lines in the model define the optimum range for the system.

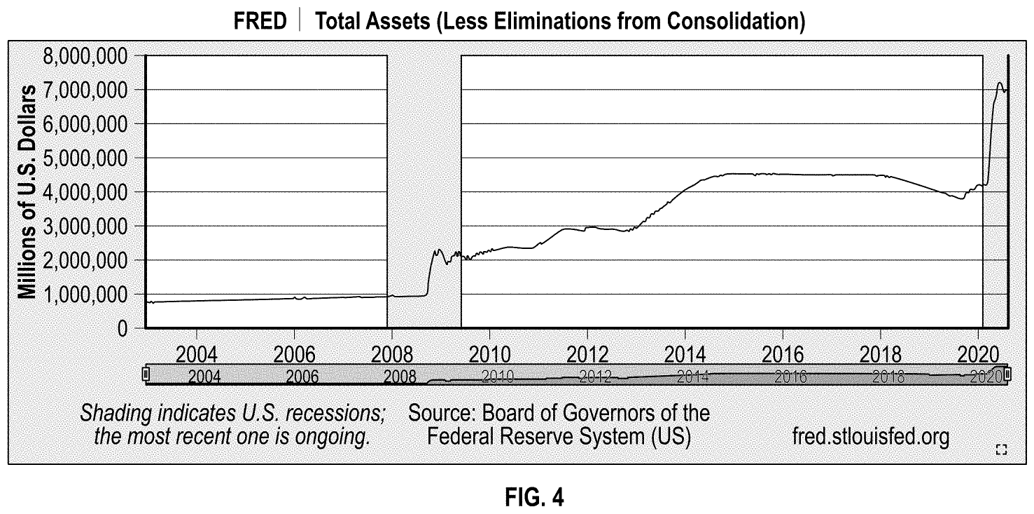

FIG. 4 shows a graph of Total Assets (Less Eliminations from Consolidation) obtained from the Board of Governors of the Federal Reserve System (US).

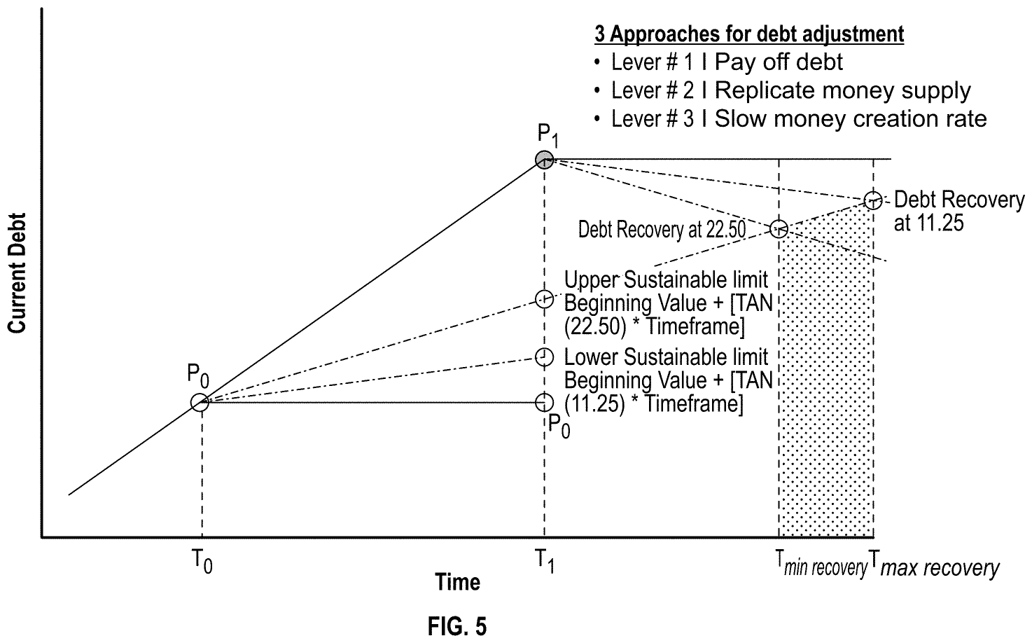

FIG. 5 illustrates a debt recovery chart according to some embodiments. In some embodiments, one or more levers for debt adjustment includes: #1 paying off debt; #2 replicating money supply; #3 slowing money creation. In some embodiments, one or more computers are configured to implement a calculation of an upper sustainable limit. In some embodiments, the system is configured to calculate a sustainable limit trajectory from a point P₀ which marks the amount of debt accruing interest which will be replaced by debt relief currency supplied at 0% interest according to some embodiments. It is noted that that graph is not to scale and the actual location of P₀ on the linear debt line depends on the implementation of some embodiments. In some embodiments, the system is configured to allow an amount of debt equal to the height of P₀ to P₁ to remain unchanged as a debt elastic component of the original debt in order to allow the money supply to fluctuate as currently designed.

In some embodiments, the system is configured to calculate the upper sustainable limit and/or the lower sustainable limit from P₀. In some embodiments, these limits define a sustainable level of accumulating debt to avoid a financial crisis. As is shown, in some embodiments the actual increase in debt from P₀ to P₁ far exceeds these upper and lower limits for debt growth, which is why the systems and methods described herein should be implemented as quickly as possible. In some embodiments, as shown in FIG. 5, the system is configured to project the upper sustainable limit and/or the lower sustainable limit past a current time P₁ for the purposes of determining a recovery rate. Like sustainable debt growth, debt recovery must also follow a principle of sustainable limits. In some embodiments, the sustained recovery limits implemented by the system includes substantially same angle as the sustainable upper and lower limits for debt growth. In some embodiments, the system is configured to determine a time for recovery by calculating the intersection of the upper sustainable limit and/or lower sustainable limit and the upper debt recovery limit (e.g., 22.50°) and the lower debt recovery limit (e.g., 11.25°), each limit defining a respective range. Since is it desirable to recover from the unsustainable debt as quickly as possible, FIG. 5 illustrates the upper debt recovery limit and the lower debt recovery limit intersecting the upper sustainable limit according to some embodiments.

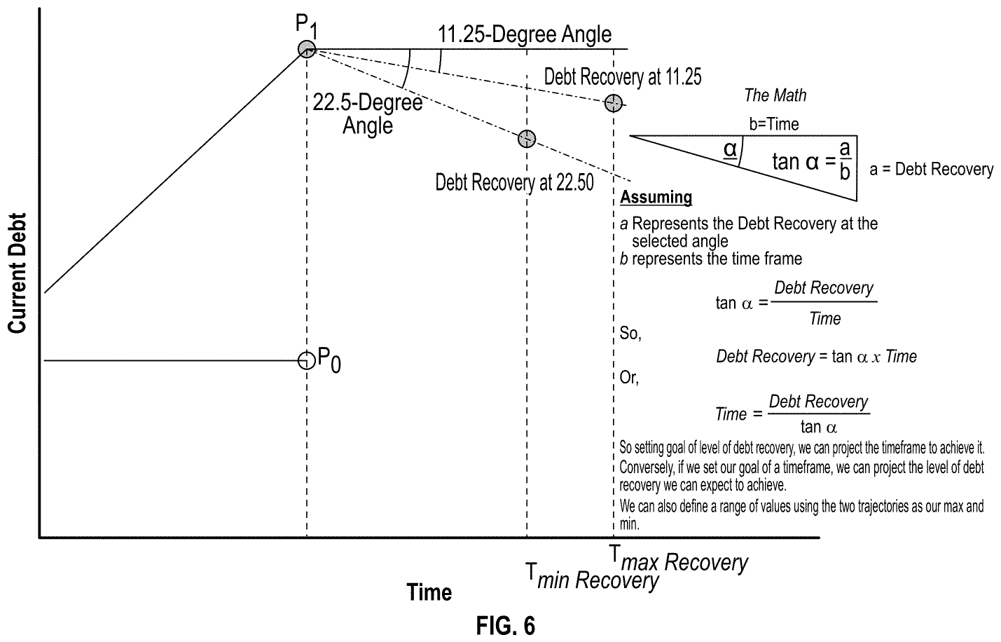

FIG. 6 shows a debt recovery timeline calculation according to some embodiments. In some embodiments, by setting a goal level of debt recovery, the system is configured to solve for the recovery timeframe using the formula as shown. In some embodiments, the system is configured to determine the level of debt recovery by solving for that variable in the recovery equation. In some embodiments, the system is configured to determine a range of debt recovery timelines by inputting the upper debt recovery limit and the lower debt recovery limit angle according to some embodiments.

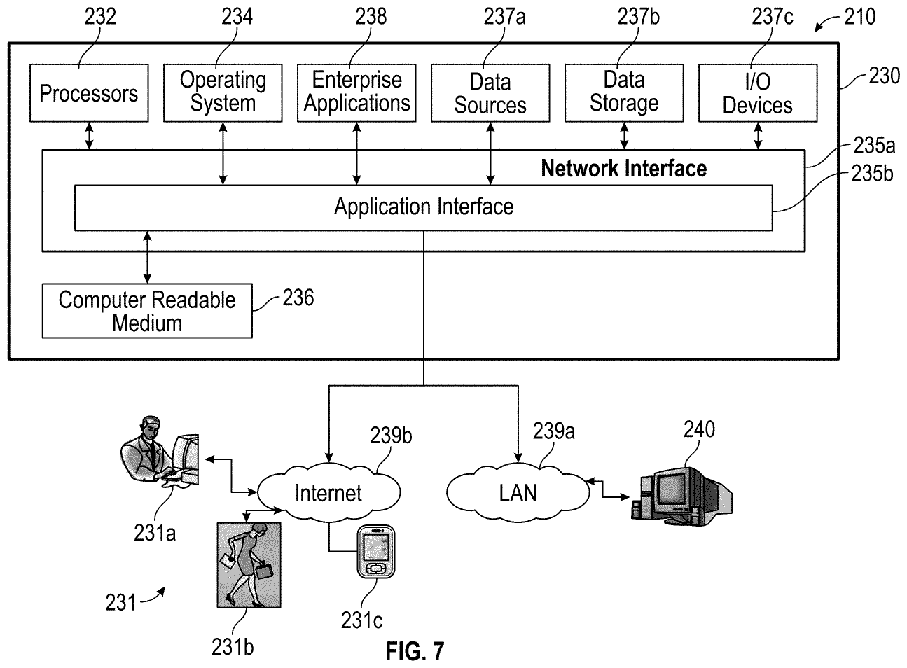

FIG. 7 illustrates a computer system 210 enabling or comprising the systems and methods in accordance with some embodiments of the system. In some embodiments, the computer system 210 can operate and/or process computer-executable code of one or more software modules of the system and method. Further, in some embodiments, the computer system 210 can operate and/or display information within one or more graphical user interfaces (e.g., HMIs) integrated with or coupled to the system.

In some embodiments, a computer implemented system for recovering from unsustainable debt growth comprises: one or more computers comprising one or more processors and one or more non-transitory computer readable media, the one or more non-transitory computer readable media including instructions stored thereon that when executed cause the one or more computers to: display, by the one or more processors, a graphical user interface (GUI); access, by the GUI, one or more financial systems comprising currency creation programs and/or debt amount databases; and execute, by the one or more processors, a command to create an amount of debt relief currency between 100% and 150% of a total debt recorded in the debt amount database. In some embodiments, the debt relief currency is created as interest free currency. In some embodiments, the one or more non-transitory computer readable media include instructions stored thereon that when executed further cause the one or more computers to: execute, by the one or more processors, a command to pay off a percentage of the total debt with an amount equal to 50% to 75% of the debt relief currency created. In some embodiments, the debt relief currency is created as interest free currency. In some embodiments, the percentage of the total debt is paid off with a first portion of the interest free currency. In some embodiments, the one or more non-transitory computer readable media include instructions stored thereon that when executed further cause the one or more computers to: accept, by the GUI, a desired time to debt recovery; calculate, by the one or more processors, an upper sustainable limit of debt growth and/or lower sustainable limit of debt growth; calculate, by the one or more processors, an upper debt recovery limit and/or lower debt recovery limit; and display, by the GUI, a chart representing the time to debt recovery. In some embodiments, the one or more non-transitory computer readable media include instructions stored thereon that when executed further cause the one or more computers to: execute, by the one or more processors, a command to replace the percentage of the total debt paid off with a remaining portion of the interest free currency.

In some embodiments, a method for a coordination of fiscal and monetary policy that is configured to create growth and stability in financial markets includes one or more method steps. In some embodiments, the method steps comprise: issuing currency in an amount that is approximately twice the amount of 62% of the Federal Balance debt as debt free money. In some embodiments, the method further includes the steps of: paying off the 62% figure of principal and interest with the debt free money; and making the remaining 38% the debt based elastic component of the Federal Balance debt. In some embodiments, the method further includes the step of: growing the money supply and attendant debt at a sustainable angle. In some embodiments, the sustainable angle is between 11.25-22.5 degrees. In some embodiments, the method further includes the step of: paying the interest on the debt based elastic component of the debt according to Section 7 Division of Earnings of the Federal Reserve Act.

In some embodiments, a method encompassed by the system described herein that comprise a method for a coordination of fiscal and monetary policy that is configured to create growth and stability in financial markets, where one or more steps are implemented by instructions stored on one or more non-transitory computer readable media and executed by one or more processors, include one or more of the following steps:

In some embodiments, a step includes determining (e.g., Congress and/or the Fed) how much of the national debt or private debt (e.g., via a commercial bank balance sheet) to restructure by analyzing the current rate of debt growth against a sustainable angle.

In some embodiments, a step includes (e.g., Congress and the Fed) would taking the current and/or real-time debt and plugging into the computer model described herein (e.g., built using the excel model as a non-limiting example guide) the base number estimate that needs to be restructured as a non-debt obligation in order to get the sustainable angle achievable via the reverse angle correction (i.e., debt recovery angle) over a determined amount of time.

In some embodiments, a step includes plugging several base levels (i.e., the amount of debt to pay with the interest free currency) into the computer model until the ideal scenario presents itself.

In some embodiments, a step includes plugging in the total current debt number and determine the angle at which the current debt number is above the base number.

In some embodiments, a step includes if the current angle of debt growth is above the ideal range (>22.5), then determining which way to get the angle of debt growth on a sustainable path via the 3 ways to adjust the debt described herein, and/or making an internal adjustment via the interest column, which does not participate in the elastic structure when allocated as interest according to some embodiments.

In some embodiments, a step includes calculating the reverse angle again between 11.25 and 22.5 as a non-disruptive adjustment range to get back down to meet the recovery angle range on the upward trajectory of debt growth in order to get back to a sustainable path of debt/money supply expansion.

In some embodiments, a step includes either plug in the dollar number or the time desired to put the reverse trajectory on the correct angle (11.25-22.5), wherein the system is configured to calculate the adjustment of the currency amount and/or calculate over what period of time this should be accomplished via the units.

In some embodiments, a step includes displaying one or more iterations of balance sheet adjustment beyond the ideal base, which gives the least disruptive angle adjustment within a projected time to revert the national debt back to the sustainable rate of growth. In some embodiments, the system is configured to ascertain this alongside other debt figures, like private debt.

In some embodiments, a step includes implementing the system through the issuance of currency using one or more computers as described herein. It is understood that all method steps described herein are part of the same system, and are readily combinable with each other to achieve the end result of financial market stability according to some embodiments.

In some embodiments, the computer system 210 can comprise at least one processor 232. In some embodiments, the at least one processor 232 can reside in, or coupled to, one or more conventional server platforms (not shown). In some embodiments, the computer system 210 can include a network interface 235a and an application interface 235b coupled to the least one processor 232 capable of processing at least one operating system 234. Further, in some embodiments, the interfaces 235a, 235b coupled to at least one processor 232 can be configured to process one or more of the software modules (e.g., such as enterprise applications 238). In some embodiments, the software application modules 238 can include server-based software, and can operate to host at least one user account and/or at least one client account, and operate to transfer data between one or more of these accounts using the at least one processor 232.

With the above embodiments in mind, it is understood that the system can employ various computer-implemented operations involving data stored in computer systems. Moreover, the above-described databases and models described throughout this disclosure can store analytical models and other data on computer-readable storage media within the computer system 210 and on computer-readable storage media coupled to the computer system 210 according to various embodiments. In addition, in some embodiments, the above-described applications of the system can be stored on computer-readable storage media within the computer system 210 and on computer-readable storage media coupled to the computer system 210. In some embodiments, these operations are those requiring physical manipulation of physical quantities. Usually, though not necessarily, in some embodiments these quantities take the form of one or more of electrical, electromagnetic, magnetic, optical, or magneto-optical signals capable of being stored, transferred, combined, compared and otherwise manipulated. In some embodiments, the computer system 210 can comprise at least one computer readable medium 236 coupled to at least one of at least one data source 237a, at least one data storage 237b, and/or at least one input/output 237c. In some embodiments, the computer system 210 can be embodied as computer readable code on a computer readable medium 236. In some embodiments, the computer readable medium 236 can be any data storage that can store data, which can thereafter be read by a computer (such as computer 240). In some embodiments, the computer readable medium 236 can be any physical or material medium that can be used to tangibly store the desired information or data or instructions and which can be accessed by a computer 240 or processor 232. In some embodiments, the computer readable medium 236 can include hard drives, network attached storage (NAS), read-only memory, random-access memory, FLASH based memory, CD-ROMs, CD-Rs, CD-RWs, DVDs, magnetic tapes, other optical and non-optical data storage. In some embodiments, various other forms of computer-readable media 236 can transmit or carry instructions to a remote computer 240 and/or at least one user 231, including a router, private or public network, or other transmission or channel, both wired and wireless. In some embodiments, the software application modules 238 can be configured to send and receive data from a database (e.g., from a computer readable medium 236 including data sources 237a and data storage 237b that can comprise a database), and data can be received by the software application modules 238 from at least one other source. In some embodiments, at least one of the software application modules 238 can be configured within the computer system 210 to output data to at least one user 231 via at least one graphical user interface rendered on at least one digital display.

In some embodiments, the computer readable medium 236 can be distributed over a conventional computer network via the network interface 235a where the system embodied by the computer readable code can be stored and executed in a distributed fashion. For example, in some embodiments, one or more components of the computer system 210 can be coupled to send and/or receive data through a local area network (“LAN”) 239a and/or an internet coupled network 239b (e.g., such as a wireless internet). In some embodiments, the networks 239a, 239b can include wide area networks (“WAN”), direct connections (e.g., through a universal serial bus port), or other forms of computer-readable media 236, or any combination thereof.

In some embodiments, components of the networks 239a, 239b can include any number of personal computers 240 which include for example desktop computers, and/or laptop computers, or any fixed, generally non-mobile internet appliances coupled through the LAN 239a. For example, some embodiments include one or more of personal computers 240, databases 241, and/or servers 242 coupled through the LAN 239a that can be configured for any type of user including an administrator. Some embodiments can include one or more personal computers 240 coupled through network 239b. In some embodiments, one or more components of the computer system 210 can be coupled to send or receive data through an internet network (e.g., such as network 239b). For example, some embodiments include at least one user 231a, 231b, is coupled wirelessly and accessing one or more software modules of the system including at least one enterprise application 238 via an input and output (“I/O”) 237c. In some embodiments, the computer system 210 can enable at least one user 231a, 231b, to be coupled to access enterprise applications 238 via an I/O 237c through LAN 239a. In some embodiments, the user 231 can comprise a user 231a coupled to the computer system 210 using a desktop computer, and/or laptop computers, or any fixed, generally non-mobile internet appliances coupled through the internet 239b. In some embodiments, the user can comprise a mobile user 231b coupled to the computer system 210. In some embodiments, the user 231b can connect using any mobile computing 231c to wireless coupled to the computer system 210, including, but not limited to, one or more personal digital assistants, at least one cellular phone, at least one mobile phone, at least one smart phone, at least one pager, at least one digital tablets, and/or at least one fixed or mobile internet appliances.

The operations performed by the system provide an improvement over conventional economic modeling techniques by providing a machine that creates an economic model that reduce debt without reducing money supply. Any methods described herein also can also be described as a computer implemented step whether directly referred to in the context of a computer or not.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Furthermore, acting as Applicant's own lexicographer, Applicant imparts the additional meaning to the following terms:

“Substantially” and “approximately” when used in conjunction with a value encompass a difference of 5% or less of the same unit and/or scale of that being measured. In some embodiments, “substantially” and “approximately” are defined as presented in the specification in accordance with some embodiments.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

The use of and/or, in terms of “A and/or B,” means one option could be “A and B” and another option could be “A or B.” Such an interpretation is consistent with the USPTO Patent Trial and Appeals Board ruling in ex parte Gross, where the Board established that “and/or” means element A alone, element B alone, or elements A and B together.

As used herein, some embodiments recited with term “can” or “may” or derivations there of (e.g., the system display can show X) is for descriptive purposes only and is understood to be synonymous with “configured to” (e.g., the system display is configured to show X) for defining the metes and bounds of the system

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless a explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A computer implemented system for recovering from unsustainable debt growth comprising:
one or more computers comprising one or more processors and one or more non-transitory computer readable media, the one or more non-transitory computer readable media including instructions stored thereon that when executed cause the one or more computers to:
display, by the one or more processors, a graphical user interface (GUI);
access, by the GUI, one or more financial systems comprising currency creation programs and/or debt amount databases; and
execute, by the one or more processors, a command to create an amount of debt relief currency between 100% and 150% of a total debt recorded in the debt amount database.

2. The system of claim 1,
wherein the debt relief currency is created as interest free currency.

3. The system of claim 1,
the one or more non-transitory computer readable media including instructions stored thereon that when executed further cause the one or more computers to:
execute, by the one or more processors, a command to pay off a percentage of the total debt with an amount equal to 50% to 75% of the debt relief currency created.

4. The system of claim 3,
wherein the debt relief currency is created as interest free currency.

5. The system of claim 4,
wherein the percentage of the total debt is paid off with a first portion of the interest free currency.

6. The system of claim 5,
the one or more non-transitory computer readable media including instructions stored thereon that when executed further cause the one or more computers to:
accept, by the GUI, a desired time to debt recovery;
calculate, by the one or more processors, an upper sustainable limit of debt growth and/or lower sustainable limit of debt growth;
calculate, by the one or more processors, an upper debt recovery limit and/or lower debt recovery limit; and
display, by the GUI, a chart representing the time to debt recovery.

7. The system of claim 5,
the one or more non-transitory computer readable media including instructions stored thereon that when executed further cause the one or more computers to:
execute, by the one or more processors, a command to replace the percentage of the total debt paid off with a remaining portion of the interest free currency.

8. A method for a coordination of fiscal and monetary policy that is configured to create growth and stability in financial markets, the method comprising the steps of:
issuing currency in an amount that is approximately twice the amount of 62% of the Federal Balance debt as debt free money.

9. The method of claim 8, further including the steps of:
paying off the 62% figure of principal and interest with the debt free money; and
making the remaining 38% the debt based elastic component of the Federal Balance debt.

10. The method of claim 9, further including the step of:
growing the money supply and attendant debt at a sustainable angle.

11. The method of claim 10,
wherein the sustainable angle is between 11.25-22.5 degrees.

12. The method of claim 11, further including the step of:
paying the interest on the debt based elastic component of the debt according to Section 7 Division of Earnings of the Federal Reserve Act.
